(19) United States
(12) Patent Application Publication
(10) Pub. No.: US 2015/0049878 A1
(43) Pub. Date: Feb. 19, 2015

(54) DIRECTIONAL MEMS MICROPHONE

(71) Applicant: Shandong Gettop Acoustic Co., Ltd., Fangzi Development Zone (CN)

(72) Inventor: WAN JINGMING, Weifang City (CN)

(73) Assignee: Shandong Gettop Acoustic Co., Ltd., Fangzi Development Zone (CN)

(21) Appl. No.: 14/270,816

(22) Filed: May 6, 2014

(30) Foreign Application Priority Data
Aug. 15, 2013 (CN) 201320498447.7

(51) Int. Cl. H04R 3/00; H04R 1/08

(52) U.S. Cl. CPC H04R 3/00; H04R 1/08; H04R 2201/003
USPC 381/92

(57) ABSTRACT

The present invention relates to a directional MEMS microphone which comprises a cover, a printed circuit board, a sound inlet structure, an integrated circuit chip which is attached to the printed circuit board, and a MEMS die which is attached to the printed circuit board. The cover provides an open side where the printed circuit board and the cover are coupled. The sound inlet structure comprises a main sound port which is disposed on the printed circuit board and communicated with the inner cavity of the MEMS die and a secondary sound port which is communicated with the inner cavity of the cover. The MEMS microphone of the present invention features with directional receiving function, simple structure and convenient application.

### CROSS-REFERENCE TO RELATED APPLICATIONS

This application is related to and claims the benefit of Chinese Utility Model Application No. 201320498447.7 filed on Aug. 15, 2013, the entire contents of which are herein incorporated by reference.

### FIELD OF THE INVENTION

This invention relates generally to a MEMS microphone. More particularly, this invention relates to a directional MEMS microphone.

### BACKGROUND OF THE INVENTION

The MEMS microphone of the prior art generally comprises a cover, a printed circuit board, an integrated circuit chip and a MEMS die which are attached to the printed circuit board. The cover provides an open side where the circuit board and the cover are coupled. The MEMS die comprises a inner cavity providing a MEMS diaphragm which is used for responding to sound pressure.

The MEMS microphones of the prior art are all omni-directional microphones which have restricted to some extent the application field and scope. Especially in many fields or products where the background noise processing or other idle noise processing may be required, the omni-directional MEMS microphone couldn't match the requirements because the sound sensitivities from different angles are equal for the omni-directional MEMS microphone. That is, sounds from various directions can all be picked up and transferred by the omni-directional MEMS microphone. However, in many specific application fields such as in a conference call, it is required for the microphone to only pick up the sound from a direction and reject or attenuate other sounds or noises. Therefore, the directional MEMS microphone is needed.

### SUMMARY OF THE INVENTION

The technical problem to be solved by the invention is to provide a simply structured and widely used MEMS microphone with directional receiving function.

To overcome the technical problem, the directional MEMS microphone of the invention comprises a cover, a printed circuit board, a sound inlet structure, an integrated circuit chip and a MEMS die which are attached to the printed circuit board. The cover provides an open side where the printed circuit board and the cover are coupled. The sound inlet structure comprises a main sound port which is disposed on the printed circuit board and communicated with the inner cavity of the MEMS die and a secondary sound port which is communicated with the inner cavity of the cover.

The secondary is disposed on the printed circuit board.

Alternatively, the secondary is disposed on the wall of the cover.

In the inner cavity of the cover, a damper is attached to the secondary sound port by adhesive.

A main sound channel and a secondary sound channel are formed by the main sound port and the secondary sound port, respectively. Meanwhile, the damper is disposed in the secondary sound channel. By the adoption of the structure, time difference is obtained when sounds arrive at the MEMS diaphragm through the main sound channel and the secondary sound channel, and then sounds from different directions will produce different sensitivities and different polarity patterns so as to realize the function of picking up a sound wave from a specified direction. Therefore, the MEMS microphone features with directional receiving function, simple structure and convenient application.

### THE DRAWINGS

The present invention will now be further described by referring to the accompanying drawings that illustrate the preferred embodiments of the invention.

FIG. 1 is a schematic sectional view of a preferred embodiment of the present invention;

FIG. 2 is a schematic sectional view of another preferred embodiment of the present invention.

### DETAILED DESCRIPTION

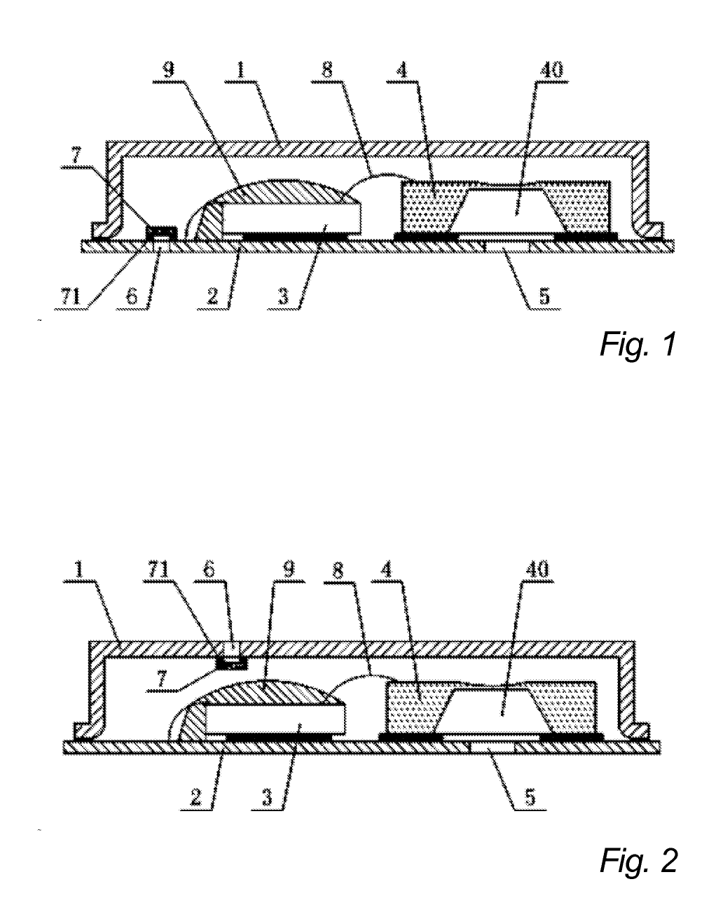

Referring to the accompanying drawings, the directional MEMS microphone of the present invention comprises a cover 1, a printed circuit board 2, a sound inlet structure, an integrated circuit chip 3 and a MEMS die 4 which are attached to the printed circuit board 2. The cover 1 provides an open side where the printed circuit board 2 and the cover 1 are coupled by adhesive. The MEMS die 4 and the integrated circuit chip 3 are attached to the printed circuit board 2 by adhesive. The integrated circuit chip 3 is connected to the MEMS die 4 and the printed circuit board 2 by metal wires 8. A special coating adhesive 9 is applied on the integrated circuit chip 3. The sound inlet structure comprises a main sound port 5 which is disposed on the printed circuit board 2 and communicated with the inner cavity 40 of the MEMS die 4 and a secondary sound port 6 which is communicated with the inner cavity of the cover 1. The secondary sound port 6 may be disposed on the printed circuit board 2 shown as FIG. 1 or on the wall the cover 1 shown as FIG. 2. Although the secondary sound port 6 may be formed in different ways, it plays the same role and depends on the need of final design. In the inner cavity of the cover 1, a damper 7 is attached to the secondary sound port 6 by adhesive 71. The damper 7 is used for adjusting the curve.

Referring to the accompanying draws, a main sound channel and a secondary sound channel are formed by the main sound port 5 and the secondary sound port 6, respectively. Meanwhile, a damper 7 is disposed in the secondary sound channel. Therefore, time difference is obtained when sounds arrive at the MEMS diaphragm through the main sound channel and the secondary sound channel, and then sounds from different directions will produce different sensitivities and different polarity patterns so as to realize the function of picking up a sound wave from a specified direction.

While the invention has been described with reference to a specific embodiment, the description is illustrative of the invention and is not to be construed a limiting the invention. It should be understood by those skilled in the art that the various changes, substitutions, and alterations could be made hereto without departing from the spirit and scope of the invention. The scope of the invention is to be limited only by the appended claims.

What is claimed is:

1. A directional MEMS microphone, comprising:
a cover which provides an open side;
a printed circuit board which is coupled to the open side of the cover;
an integrated circuit chip which is attached to the printed circuit board;
a MEMS die which is attached to the printed circuit board;
a sound inlet structure which comprises a main sound port which is disposed on the printed circuit board and communicated with the inner cavity of the MEMS die and a secondary sound port which is communicated with the inner cavity of the cover.

2. The directional MEMS microphone of claim 1 wherein the secondary sound port is disposed on the printed circuit board.

3. The directional MEMS microphone of claim 1 wherein the secondary sound port is disposed on the wall of the cover.

4. The directional MEMS microphone of claim 1 wherein a damper is attached to the secondary sound port of the inner cavity of the cover by adhesive.

5. The directional MEMS microphone of claim 2 wherein a damper is attached to the secondary sound port of the inner cavity of the cover by adhesive.

6. The directional MEMS microphone of claim 3 wherein a damper is attached to the secondary sound port of the inner cavity of the cover by adhesive.
